(19) United States
(12) Patent Application Publication
(10) Pub. No.: US 2006/0242588 A1
(43) Pub. Date: Oct. 26, 2006

(54) Scheduled transmissions for portable devices

(75) Inventors: Sima Ybarra, San Diego, CA (US); Nematolah Kashanian, Hackensack, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/111,051

(22) Filed: Apr. 20, 2005

(51) Int. Cl. G06F 9/46; G06F 1/24

(52) U.S. Cl. 715/748; 718/102; 713/100; 709/238

(57) ABSTRACT

A system for a portable device may include reception of a schedule for the transmission of data to an external device, determination, based at least in part on the schedule, that the data is to be transmitted, and, in response to the determination, transmission of the data from the portable device to the external device. According to some aspects, a portable device includes an input device to receive a schedule for the transmission of data to an external device, a scheduling device to determine, based at least in part on the schedule, that the data is to be transmitted, and a communication device to transmit the data from the portable device to the external device in response to the determination.

### BACKGROUND

1. Field

Embodiments may relate to transmissions from portable devices. More particularly, some embodiments are concerned with the scheduling of transmissions from a portable device and/or the transmission of a scheduled transmission from a portable device.

2. Description

Many types of portable electronic devices are currently available to consumers. A non-exhaustive list of such devices includes cellular telephones, personal digital assistants (PDAs), wireless email devices, and digital media players. Although each of the foregoing devices is associated with a “core” function (i.e., telephone communication, scheduling, email, and music playback, respectively), some conventional portable electronic devices provide two or more unrelated functions.

For example, many cellular telephones include features for capturing digital images. Similarly, some PDAs provide telephone communication and Web browsing. Digital media players may also provide Web browsing or digital recording. In some cases, a portable electronic device providing multiple functions cannot adequately be identified by only one of the broad category names mentioned above.

Some portable electronic devices do not satisfactorily integrate the multiple functions that they provide. If integrated together in a particular way, some of these functions could provide an additional function. The integration may therefore reduce a need to manually execute the additional function or to employ another device to provide the additional function. Improved integration of portable device functions is therefore desired.

### SUMMARY

According to some embodiments, a portable device includes an input device to receive a schedule for the transmission of data to an external device, a scheduling device to determine, based at least in part on the schedule, that the data is to be transmitted, and a communication device to transmit the data from the portable device to the external device in response to the determination. In some aspects, the data comprises a text message. Such a text message may comprise an email message according to some embodiments. Some aspects include transmission of a request for an email message to the external device.

Embodiments may also provide a system, method, program code and/or means to receive a schedule for the transmission of data to an external device, determine, based at least in part on the schedule, that the data is to be transmitted, and, in response to the determination, transmit the data from the portable device to the external device. In some aspects, transmission of the data comprises placing a telephone call. The data may comprise a text message, a request for an email message, and/or a request for WAP data according to some aspects.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram of a system according to some embodiments;

FIG. 2 is a flow diagram of a process according to some embodiments;

FIG. 3 is an outward view of a telephone according to some embodiments;

FIG. 4 is a block diagram of the internal architecture of a telephone according to some embodiments;

FIG. 5 is a block diagram of the software architecture of a telephone according to some embodiments;

FIG. 6 is a flow diagram of a process according to some embodiments;

FIG. 7 is an outward view of a telephone according to some embodiments;

FIG. 8 is an outward view of a telephone according to some embodiments;

FIG. 9 is an outward view of a telephone according to some embodiments;

FIG. 10 is an outward view of a telephone according to some embodiments;

FIG. 11 is an outward view of a telephone according to some embodiments;

FIG. 12 is an outward view of a telephone according to some embodiments;

FIG. 13 is a flow diagram of a process according to some embodiments; and

FIG. 14 is a diagram of a system architecture according to some embodiments.

### DETAILED DESCRIPTION

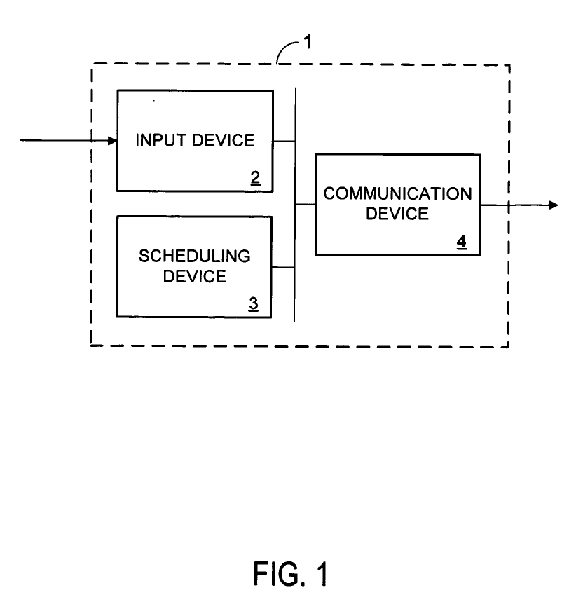

FIG. 1 is a block diagram of device 1 according to some embodiments. Device 1 may receive a schedule for the transmission of data to an external device and may determine, based at least in part on the schedule, that the data is to be transmitted. In response to the determination, device 1 may transmit the data to the external device.

Device 1 may comprise a portable device. Examples of portable devices include cellular telephones, PDAs, digital media players, digital cameras, wireless email devices, and any other portable device for transmitting data to an external device that is or becomes known.

Device 1 includes input device 2, scheduling device 3 and communication device 4. According to some embodiments, input device 2 receives a schedule for the transmission of data to an external device. A schedule may specify one or more of a transmission type, a transmission time, and the data to be transmitted. Input device 2 may comprise one or more of a keypad, a touch-sensitive screen, a keyboard, a communication port (e.g., an infrared port, a serial port, a USB port), a microphone, and any other device usable to receive a schedule.

Scheduling device 3 may determine that the data is to be transmitted, based at least in part on the schedule received by input device 2. Scheduling device 3 may comprise any suitable combination of hardware and/or software. Scheduling device 3 may comprise a processor that executes program code of an alarm application, a timer application, a scheduling application, or other application. Scheduling device 3 may include a clock to track a current date and time. Scheduling device 3 may instruct communication device 4 to transmit the data specified by the schedule.

More specifically, some embodiments of communication device 4 transmit the data from portable device 1 to an external device in response to the determination by scheduling device 3. Communication device 4 may comprise any element or elements for transmitting data to an external device. Examples of communication device 4 include but are not limited to an RF transceiver and antenna, an infrared port, and a USB port. In some embodiments, communication device 4 and input device 2 share one or more elements. For example, the schedule may be received via an infrared port and the data may be transmitted to an external device from the infrared port.

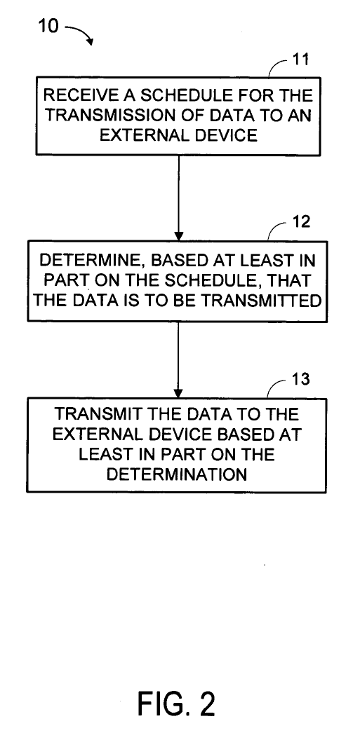

FIG. 2 is a flow diagram of process 10 according to some embodiments. Process 10 may be embodied in program code and/or executed by device 1 or another device using any suitable hardware and/or software arrangement.

Process 10 begins at 11, in which a schedule is received. The schedule relates to the transmission of data to an external device. The schedule may, in some embodiments, include a date, a time, the particular data to be transmitted, and details regarding the system by which the data is to be transmitted (i.e., the transmission type). The schedule may also or alternatively include one or more conditions to be met prior to transmitting the data. Examples of schedules and systems for receiving schedules according to some embodiments will be provided below.

Next, at 12, it is determined that the data is to be transmitted. The determination may be based at least in part on the schedule received at 11. For example, a current date and time may be determined based on an internal or an external clock. If the current date and time is substantially equivalent to the date and the time specified by the received schedule, it is determined that the data is to be transmitted.

The data is then transmitted to the external device at 13. The transmission may proceed based on a transmission type specified by the received schedule. In some examples, the transmission type comprises a Code Division Multiple Access (CDMA) telephone call transmitted via an RF antenna.

In an operational example of process 10 according to some embodiments, scheduling device 3 presents a scheduling application to a user via a display (not shown) of device 1. At 11, the user operates input device 2 to input a schedule comprising a date and time into a user interface of the scheduling application. The schedule also indicates that a telephone call should be placed at the date and time, and provides a telephone number to which the call should be placed. Next, scheduling device 3 evaluates the received schedule to determine if the date and time of the schedule correspond to a current date and time. Eventually, scheduling device 3 determines that the current date and time correspond to the scheduled date and time. In response, scheduling device 3 issues an instruction that causes communication device 4 to place a telephone call to the provided telephone number.

Some embodiments may function slightly or completely differently than the foregoing example. As non-exhaustive examples, the scheduled transmission may comprise a text message sent via any currently- or hereafter-known text messaging service. Conventional examples include Internet Messenger (IM), Short Message Service (SMS), Multimedia Message Service (MMS), and Enhanced Message Service (EMS). In some embodiments, the transmission may comprise electronic mail, a request for electronic mail that is transmitted to a mail server, or a request for Web data such as a Web page or Wide-Area Protocol (WAP) data. The transmission may also or alternatively comprise a Bluetooth transmission, a WiFi transmission, or a WiMax transmission. The data may be transmitted to any external device that is capable of receiving the transmission.

Some embodiments of the FIG. 1 system and/or the FIG. 2 system provide more efficient data transmission than previously available.

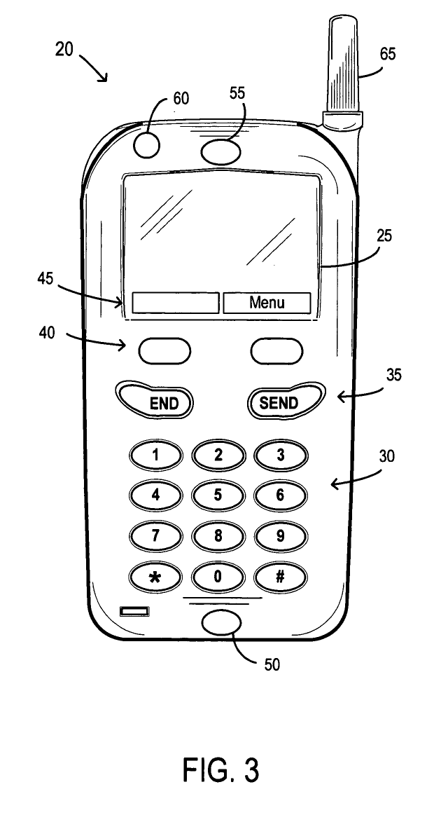

FIG. 3 is a view of portable cellular telephone 20. Cellular telephone 20 may comprise device 1 of FIG. 1 and/or may execute process 10 according to some embodiments. Cellular telephone 20 may include conventional components, and may include program code for performing certain functions described herein. Some embodiments may differ in part or in whole from cellular telephone 20.

Cellular telephone 20 may be compatible with one or more cellular communication protocols. Examples of such protocols include but are not limited to CDMA, Time Division Multiple Access (TDMA) (e.g., GSM, D-AMPS), and CDMAOne (e.g., PCS). Embodiments are not limited to devices offering cellular and/or telephone functionality.

Cellular telephone 20 includes display 25, keypad 30, fixed function keys 35, variable function keys 40, function key labels 45, microphone 50, speaker 55, power button 60 and antenna 65. Display 25 presents a user interface for accessing the functionality of telephone 20. Alphanumeric keypad 30 is laid out like a conventional telephone dialing keypad, and fixed function keys 35 are used to initiate a communication and to terminate a communication. Variable function keys 40 provide functions that vary in accordance with function labels 45 displayed on display 25 above keys 40.

Microphone 50 receives audio signals from a user. The signals may comprise speech to be transmitted according to a schedule. The audio signals may also or alternatively comprise elements of a schedule (e.g., date, time, transmission type) and/or commands for operating telephone 20.

Speaker 55 emits audio signals from telephone 20. The audio signals may comprise ring tones, beeps, alarms, and other tones used during operation of telephone 20, and/or speech or other audio signals received from another device such as another telephone. Speaker 55 may also emit audio signals representing speech or other sounds received by microphone 50.

Power button 60 may be used to turn cellular telephone 20 on and off. Antenna 65 may receive and transmit radio frequency signals from and to a cellular telephone network. Antenna 65 may be configured to transmit and receive any types of signals that comply with the communication protocol of the communication network in which telephone 20 is employed.

In some examples of operation, a user operates keys 40 to launch a scheduling application. A user interface of the scheduling application is displayed on display 25. The user interface allows the user to input a schedule which may include a transmission time, data to be transmitted, and a transmission type. The schedule may be input using keypad 30, microphone 50 and/or keys 40.

At the scheduled transmission time, program code of the scheduling application is executed to determine that the data is to be transmitted. The data is therefore transmitted according to the specified transmission type. The transmission type may comprise a telephone call, text message, and/or request for WAP data transmitted from antenna 65.

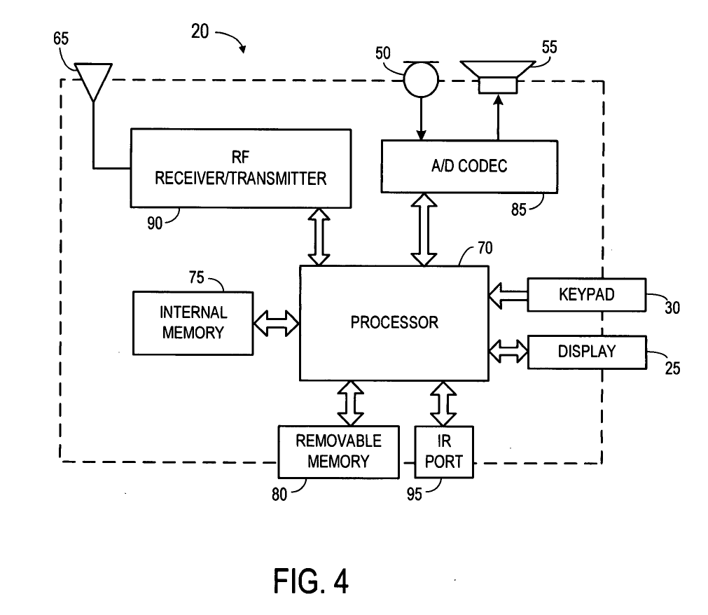

FIG. 4 is a block diagram of the internal architecture of cellular telephone 20 according to some embodiments. As shown, cellular telephone 20 includes processor 70, which may be a conventional microprocessor, microcontroller and/or digital signal processor (DSP) or other control circuit conventionally provided in a cellular telephone. Processor 70 is shown in communication with keypad 30 and display 25 for control thereof.

Also included in the cellular telephone 20 are internal memory 75 and removable memory 80. Internal memory 75 may include one or more of ROM (read only memory), RAM (random access memory, e.g., static RAM), and flash memory. Removable memory 80 may comprise a flash memory, a Subscriber Identity Module (SIM) card or any other removable memory that is or becomes known. Cellular telephone 20 may therefore be equipped with an interface for physically receiving and transferring data to and from removable memory 80.

Memories 75 and 80 may store program code that is executable by processor 70 to control telephone 20. The program code may include but is not limited to operating system program code, application program code, device driver program code, and database connector program code. The program code may include code to cause telephone 20 to perform functions that are described herein.

Memories 75 and 80 may also store data used in the operation of cellular telephone 20. Such data may include phone numbers, addresses, access codes, email addresses, audio files, and other data. Some or all of the data may be read-only, while other of the data may be rewritable.

Analog/digital coder/decoder (A/D codec) 85 is also in communication with processor 70. A/D codec 85 may receive analog signals from microphone 50, convert the analog signals to digital signals, and pass the digital signals to processor 70. Conversely, processor 70 may transmit digital signals to A/D codec 85, which converts the digital signals to analog signals and passes the analog signals to speaker 55. Speaker 55 then emits sound based on the analog signals.

RF receiver/transmitter 90 is operatively coupled to antenna 65. RF receiver/transmitter 90 may, in accordance with conventional practices, comprise a combination of two or more different receive/transmit modules (not separately shown) that operate in accordance with mutually different radio communication protocols to provide various services for the cellular telephone 20. For example, receiver/transmitter 90 may operate in accordance with one radio communication protocol to provide conventional two-way service for cellular telephone 20, and may operate in accordance with another radio communication protocol to provide PoC service for cellular telephone 20.

Those in the art will understand that the block diagram of FIG. 4 is simplified in a number of ways. For example, all power and power management components of cellular telephone 20 are omitted from the diagram. Also, some embodiments may employ an internal architecture somewhat or completely different from that shown in FIG. 4.

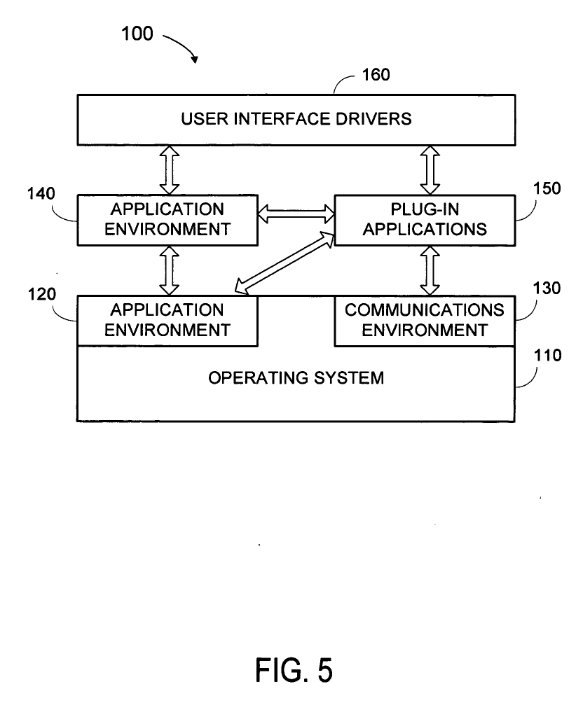

FIG. 5 is a block diagram of a general software architecture that may be used within cellular telephone 20 in conjunction with some embodiments. Architecture 100 may operate to receive a schedule for the transmission of data to an external device, determine, based at least in part on the schedule, that the data is to be transmitted, and, in response to the determination, transmit the data from the portable device to the external device. Any suitable operating system may be used in conjunction with some embodiments, including those not intended and/or usable with cellular telephones. Suitable operating systems according to some embodiments include but are not limited to Palm OS™, Windows CE™, and operating systems suitable for portable devices capable of transmissions to an external device (e.g., PDAs, digital media players, etc.).

Architecture 100 includes operating system 110, which may comprise the Symbian® cellular telephone operating system. Application environment 120 provides a platform by which another application environment 140 may interface with operating system 110. In this regard, application environment 140 may comprise a Java™ or C programming environment. As such, plug-in applications 150 may be written in Java or C for execution by cellular telephone 20. Plug-in applications 150 may also be written for the application interface provided by application environment 120.

Communications environment 130 provides plug-in applications 150 with access to the communications functionality of operating system 110. This functionality may include text messaging, email client functions, Web browsing and telephone communication. Plug-in applications 150 may also transmit data and commands to and receive input from user interface drivers 160 for control of the user interfaces of telephone 20.

Some embodiments comprise a standalone scheduling application that interfaces with application environment 140 and/or application environment 120. According to some embodiments, operating system 110 and/or application environment 120 provide an application programming interface that allows client applications to schedule a transmission, determine that the data is to be transmitted, and, in response to the determination, transmit the data from the portable device to the external device

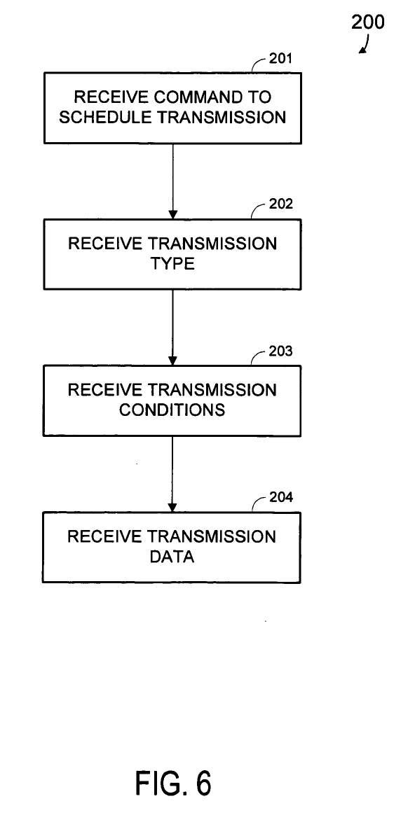

FIG. 6 is a flow diagram of process 200 according to some embodiments. Process 200 may be embodied in hardware and/or software of device 1, telephone 20, or one or more other suitable devices. In the foregoing description, process 200 will be described as if embodied in program code of one of plug-in applications 150. As described above, such program code may be executable within a multi-platform environment such as application environment 140 and/or within the environment provided by application environment 120. Process 200 may also be embodied in native program code of telephone 20. Process 200 may be executed by a device partially or completely different from telephone 20, including but not limited to devices that do not provide telephone functionality.

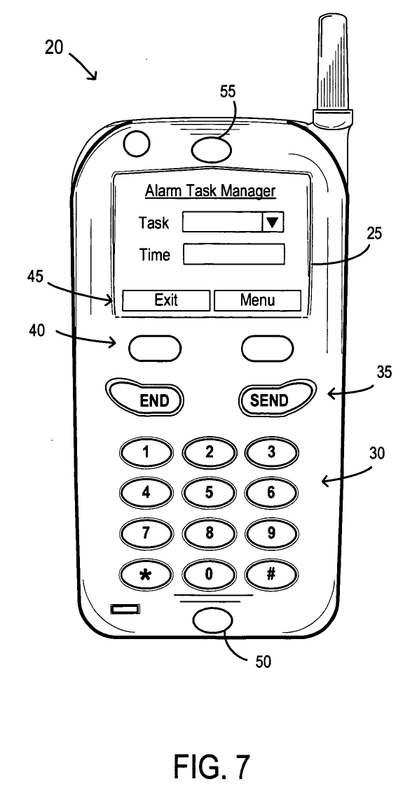

Initially, at 201, cellular telephone 20 receives a command to schedule a transmission. For example, a user may manipulate keypad 30 and variable function keys 40 to enter commands to launch an application providing transmission scheduling. As a result, display 25 may present an interface of the application. FIG. 7 is an outward view of cellular telephone 20 after 201 according to some embodiments. Display 25 presents a main interface of an Alarm Task Manager application.

A transmission type is then received at 202. In some embodiments, a user inputs the transmission type into the Task field of the main interface. The illustrated embodiment provides a pull-down list of tasks (i.e. transmission types) provided by the application. A transmission type may be selected from the pull-down list and thereby received by telephone 20 using an input device of telephone 20. In this regard, display 25 may comprise a touch screen and therefore function as both an input device and an output device.

The present example provides several tasks, entitled Wakeup Call, Messenger, eMail, and Web Download. These tasks respectively correspond to transmission types of a telephone call, a text message, an email transmission, and a request for WAP data. Any other types of transmissions to an external device that are or become known may be used in conjunction with some embodiments.

One or more transmission conditions are received at 203. The scheduled transmission will occur if telephone 20 determines that the received conditions are satisfied. The transmission condition according to the present example is a time of day. Therefore, a transmission of the type specified in the Task field will occur at the time of day that is input in the Time field of the main interface presented by display 25. Other transmission conditions may be specified according to some embodiments. Such conditions include but are not limited to a date, a state of telephone 20, receipt of a particular transmission, external data (e.g., weather, stock quotes, etc.) received from an external source (e.g., Web page, RSS feed, email, etc.) and any other condition that may be evaluated.

The user may then select function key 40 associated with OK function label 45. As a result, telephone 20 receives and stores the transmission type and transmission condition presented by display 25. Next, at 204, data of the transmission is received.

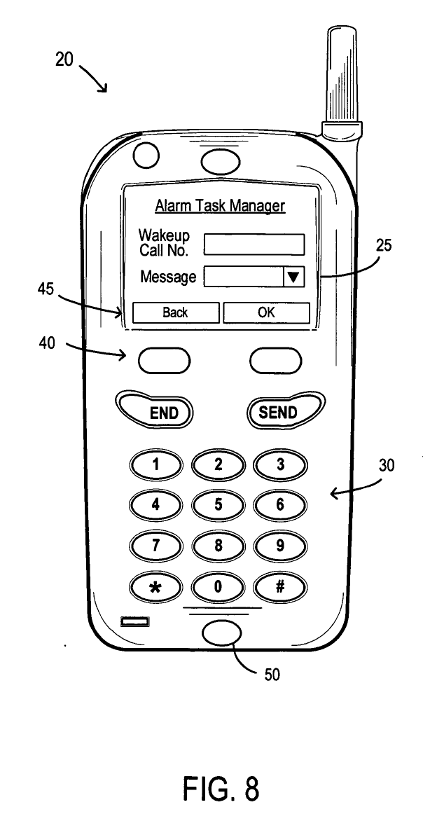

FIGS. 8 through 11 illustrate interfaces to receive transmission data for various transmission types according to some embodiments. FIG. 8, for example, shows display 25 presenting a user interface to receive transmission data for a Wakeup Call task. The interface includes a Wakeup Call No. field and a Message field. The user may operate keypad 30 or another input device to input a telephone number into the Wakeup Call No. field. The transmission type associated with the Wakeup Call function is a telephone call, and the input telephone number is a number to which the telephone call will be placed.

The Message field includes a pull-down box for selecting one of several messages. The messages may be provided with the scheduling application or telephone 20, may be downloaded to memory 75 and/or may be stored in memory 80. The messages may comprise speech, music, electronic communication signals (facsimile or DTMF tones) or any other data that may be transmitted in a telephone call. The messages may comprise speech spoken by the user into microphone 50 and stored in telephone 20 prior to process 200.

In the embodiments of FIGS. 8 through 11, the user may select function key 40 associated with OK function label 45 to store the transmission data in telephone 20. The function key 40 associated with Back function label 45 may be selected to return to the main interface without saving the input data.

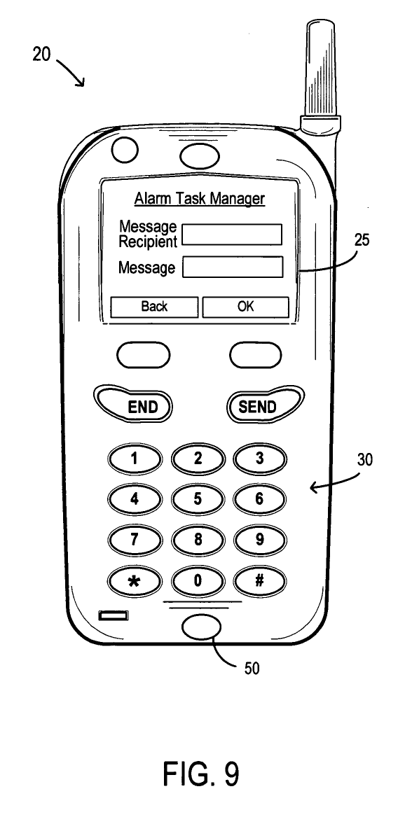

FIG. 9 shows a user interface to receive transmission data at 204 for a Messenger task. The Messenger task corresponds to a text message transmission type. A text message may be transmitted using any system for transmitting text, including but not limited to IM, SMS, MMS, and EMS. The interface of FIG. 9 includes a Message Recipient field for providing data needed to contact an intended recipient of the text message. The recipient may be another user or a device that may be controlled by transmitting text messages thereto. The data in Message Recipient field may comprise a telephone number, an IM screen name, an email address, a network address, or other recipient information. The user may type the actual message to be transmitted into the displayed Message field using keypad 30 or another input device. Some embodiments provide a pull-down box for the Message field to allow easy selection of a pre-stored text message.

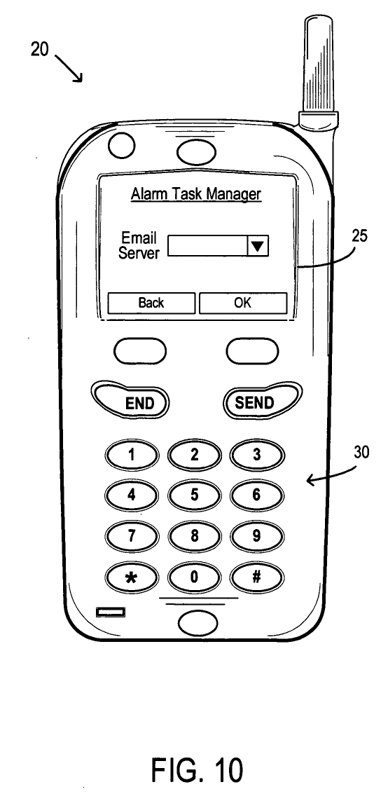

Display 25 of FIG. 10 presents a user interface to receive transmission data for an eMail task. The eMail task corresponds to an email transmission type. An email transmission type according to the present example comprises a transmission to request email, and therefore requires information regarding an email server from which the email can be requested. The Email server field of FIG. 10 is used to receive an email server name. The user may type the email server name into the Email server field using keypad 30 or another input device. Some embodiments provide a pull-down box for the Email server field to access previously used email servers. In some embodiments, an email transmission type comprises the transmission of an email message, and therefore requires an email address to which the message will be sent.

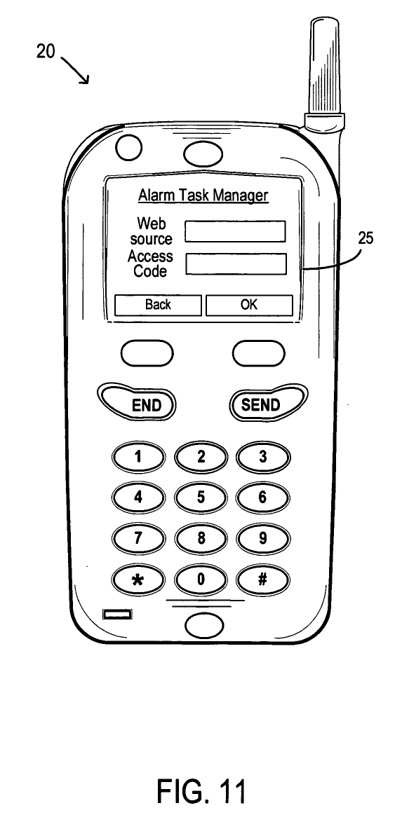

FIG. 11 shows display 25 presenting a user interface to receive transmission data at 204 for a Web Download task. The interface includes a Web Source field to identify the Web resource from which data is to be downloaded. The Web resource may provide data according to any protocol, therefore the transmission type associated with the Web download task may comprise a request for WAP data or any other suitable type of data. In some embodiments, the Web Download task may provide weather, news, financial, sports, and/or other information. Also provided are an Access Code field to receive any information that may be required by the Web resource prior to downloading the requested data.

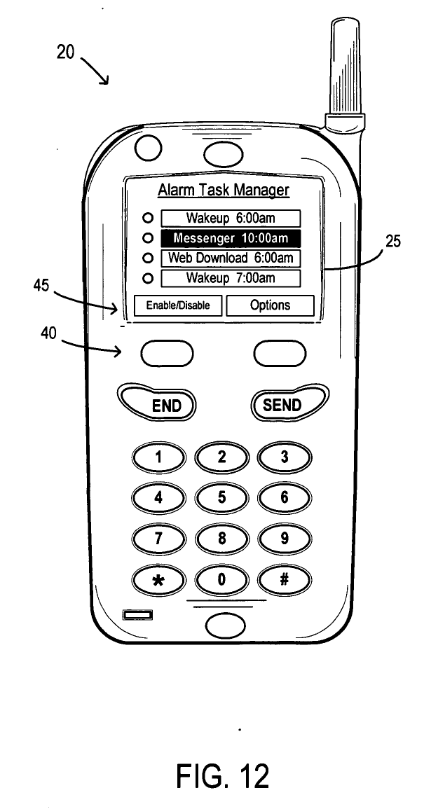

FIG. 12 is a view of an interface displayed by the transmission scheduling application on display 25 according to some embodiments. The interface lists several already-scheduled transmissions and allows user selection thereof. A selected transmission may be enabled or disabled using function key 40 associated with Enable/Disable label 45.

A user may operate function key 40 associated with Options label 45 to access options associated with a selected scheduled transmission. The options may be displayed in a window on top of the interface of FIG. 12 or in another interface. According to some embodiments, the options include functions to view details of the selected transmission, to edit details of the selected transmission, and to delete the selected transmission.

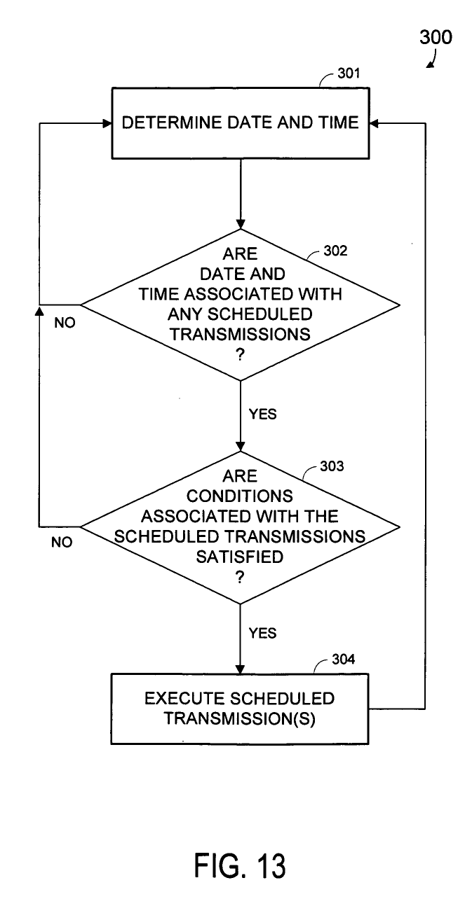

FIG. 13 is a flow diagram of process 300 to execute a scheduled transmission according to some embodiments. Process 300 may be embodied in any hardware and/or software of device 1, telephone 20, or one or more other suitable devices, but will be described as if embodied in program code of the transmission scheduling application of telephone 20 that was used to describe process 200. Some embodiments of process 300 may be embodied by hardware and/or software different from that used to define a scheduled transmission according to process 200.

A current date and time are determined at 301. The time may be determined based on a clock and/or timer internal to telephone 20, and/or based on data received from an external source. For example, telephone 20 may maintain an internal clock that is corrected based on information transmitted by and received from a reference clock such as an atomic clock.

Next, at 302, it is determined whether the date and time are associated with any scheduled transmissions. According to some embodiments, scheduled transmissions that have been disabled are not evaluated at 302. Flow returns to 301 if the date and time are not associated with any scheduled transmissions.

If the date and time are associated with one or more scheduled transmissions, flow continues to 303 to determine if conditions associated with each of the one or more scheduled transmissions are satisfied. As described above, any conditions may be associated with a scheduled transmission and any currently- or hereafter-known system may be used to evaluate the conditions.

In some embodiments, 302 may be omitted for scheduled transmissions that are not associated with conditions other than a date and/or time. Similarly, 303 may be omitted for scheduled transmissions that are not associated with a date and/or time. Some embodiments of 300 may replace decision nodes 302 and 303 with a single decision node indicating a determination, based at least in part on the schedule, whether the data is to be transmitted.

The scheduled transmissions associated with satisfied conditions are executed at 304. More particularly, in response to the determinations of 302 and 303, data is transmitted by a portable device to an external device. Flow then returns to 301. Flow also returns to 301 if it is determined at 303 that no scheduled transmissions are associated with satisfied conditions.

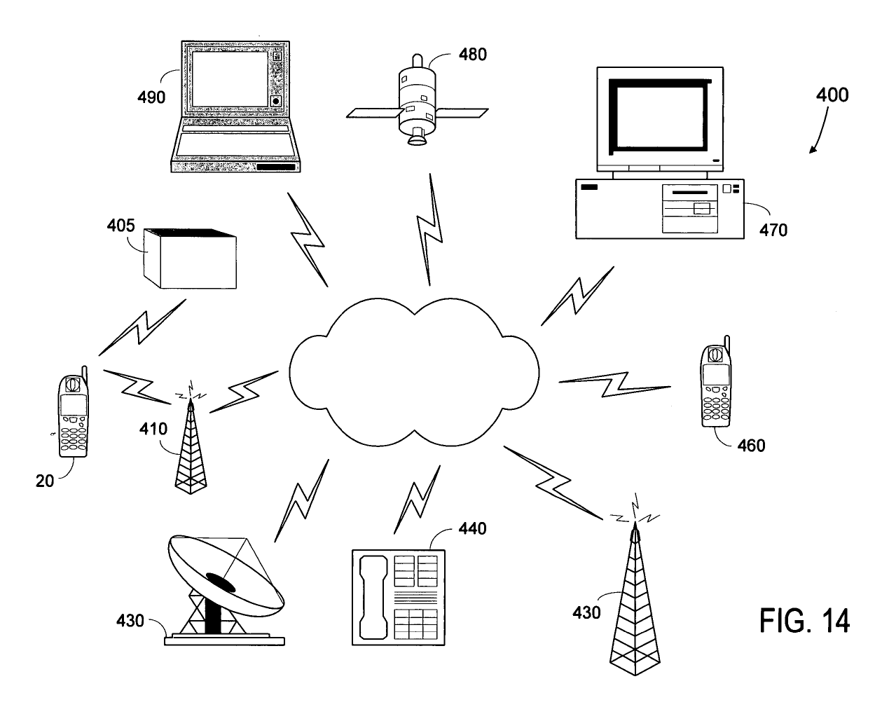

The data may pass through any number of networks, devices and protocols before reaching the external device. FIG. 14 is a partial diagram of system 400 according to some embodiments. System 400 may be used to deliver the transmitted data from cellular telephone 20 to its intended recipient external device.

Cellular telephone 20 is shown in direct communication with appliance 405 and tower 410. Appliance 405 may comprise any device capable of receiving transmissions from telephone 20. Examples include but are not limited to an infrared-enabled computer printer, a Bluetooth-enabled coffee maker, and a landline telephone (e.g., a cordless phone or a corded phone).

Tower 410 may receive a transmission directly from antenna 65, and may forward the transmission to communication network 420 according to governing protocols. Communication network 420 may include any number of devices and systems for transferring data, including but not limited to local area networks, wide area networks, telephone networks, cellular networks, fiber-optic networks, satellite networks, infra-red networks, radio frequency networks, and any other type of networks which may be used to transmit information between devices. Additionally, data may be transmitted through communication network 420 using one or more currently- or hereafter-known network protocols, including but not limited to Asynchronous Transfer Mode (ATM), Internet Protocol (IP), Hypertext Transfer Protocol (HTTP) and Wireless Application Protocol (WAP).

Devices 430 through 490 are examples of some devices that may be a part of or in communication with communication network 420. As such, devices may receive data of a scheduled transmission, either as intended recipient or as a network node for passing on the data. Devices 430 through 490 include satellite transmitter/receiver 430, landline telephone 440, communication tower 450, cellular telephone 460, desktop computer 470, satellite 480 and laptop computer 490. Any other suitable devices may be used in conjunction with some embodiments.

The elements of system 400 may be connected differently than as shown. For example, some or all of the elements may be connected directly to one another. Embodiments may include elements that are different from those shown. Moreover, although the illustrated communication links between the elements of system 400 appear dedicated, each of the links may be shared by other elements. Elements shown and described as coupled or in communication with each other need not be constantly exchanging data. Rather, communication may be established when necessary and severed at other times or always available but rarely used to transmit data.

The processes described herein may be embodied as program code developed using an object-oriented language that allows the modeling of complex systems with modular objects to create abstractions that are representative of real world, physical objects and their interrelationships. However, embodiments may be implemented in many different ways using a wide range of programming techniques as well as general-purpose hardware systems or dedicated controllers. In addition, in some embodiments, many, if not all, of the elements described above are optional or can be combined into single elements.

Embodiments described above are not intended to be limited to the specific form set forth herein, but are intended to cover such alternatives, modifications and equivalents as can reasonably be included within the spirit and scope of the appended claims.

What is claimed is:

1. A method for a portable device, comprising:
receiving a schedule for the transmission of data to an external device;
determining, based at least in part on the schedule, that the data is to be transmitted; and
in response to the determination, transmitting the data from the portable device to the external device.

2. A method according to claim 1, wherein the portable device is a telephone.

3. A method according to claim 1, wherein transmitting the data comprises placing a telephone call.

4. A method according to claim 1, wherein the data comprises a text message.

5. A method according to claim 4, wherein the text message comprises an email message.

6. A method according to claim 1, wherein the data comprises a request for an email message.

7. A method according to claim 6, further comprising:
receiving the email message; and
presenting the email message.

8. A method according to claim 1, wherein the data comprises a request for WAP data from a WAP network.

9. A method according to claim 8, further comprising:
receiving the WAP data; and
presenting the WAP data.

10. A method according to claim 1, wherein transmitting the data from the portable device to the external device comprises:
transmitting the data from an infrared port of the portable device.

11. A portable device comprising:
an input device to receive a schedule for the transmission of data to an external device;
a scheduling device to determine, based at least in part on the schedule, that the data is to be transmitted; and
a communication device to transmit the data from the portable device to the external device in response to the determination.

12. A device according to claim 11, wherein the portable device is a telephone.

13. A device according to claim 11, wherein the data comprises a telephone call.

14. A device according to claim 11, wherein the data comprises a text message.

15. A device according to claim 14, wherein the text message comprises an email message.

16. A device according to claim 11, wherein the data comprises a request for an email message.

17. A device according to claim 16, the communication device to receive the email message, the device further comprising:
an output device to present the email message.

18. A device according to claim 11, wherein the data comprises a request for WAP data from a WAP network.

19. A device according to claim 18, the communication device to receive the WAP data, the device further comprising:
an output device to present the WAP data.

20. A device according to claim 11, wherein the communication device comprises:
a infrared port to transmit the data.

21. A medium storing program code, the program code comprising:
code to receive a schedule for the transmission of data to an external device;
code to determine, based at least in part on the schedule, that the data is to be transmitted; and
code to transmit the data from the portable device to the external device in response to the determination.

22. A medium according to claim 21, wherein the data comprises a text message.

23. A medium according to claim 22, wherein the text message comprises an email message.

24. A medium according to claim 21, wherein the data comprises a request for WAP data from a WAP network.
